(19) United States
(12) Patent Application Publication
(10) Pub. No.: US 2010/0007517 A1
(43) Pub. Date: Jan. 14, 2010

(54) SYSTEMS AND METHODS FOR AN ELECTRONIC PRESENTATION CONTROLLER

(76) Inventors: Nicholas David Andrews, Kowloon (HK); Chris Wing Ho Fu, Richmond (CA); Ron DeCamp, Westminster, CA (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/502,847

(22) Filed: Jul. 14, 2009

Related U.S. Application Data
(60) Provisional application No. 61/080,540, filed on Jul. 14, 2008.

(51) Int. Cl. G08C 19/00

(52) U.S. Cl. 340/825.69

(57) ABSTRACT

The present disclosure relates to an electronic presentation controller that allows an orator to select features that the orator may use during a presentation, and disable other features of the electronic presentation controller. An electronic presentation controller according to the present disclosure may include a wide range of advanced features, that may be activated or deactivated selectively, thus minimizing the potential for unwanted and potentially embarrassing interruptions during presentation by disabling functions that are not being used by the orator.

### RELATED APPLICATIONS

This application claims the benefit under 35 U.S.C. § 119(e) of U.S. Provisional Patent Application No. 61/080,540, entitled “Key Lock Presenter Apparatus,” filed Jul. 14, 2008, which is incorporated by reference in its entirety.

### TECHNICAL FIELD

The present disclosure relates to an electronic presentation controller that allows an orator to select features that the orator may use during a presentation and disable other features of the presentation controller. An electronic presentation controller according to the present disclosure may include a wide range of advanced features, that may be activated or deactivated selectively, thus minimizing the potential for unwanted and potentially embarrassing interruptions during a presentation by disabling functions that are not being used by the orator.

Additional aspects and advantages will be apparent from the following detailed description of preferred embodiments, which proceeds with reference to the accompanying drawings.

### BRIEF DESCRIPTION OF THE DRAWINGS

FIG. 1 illustrates a common setup for an electronic presentation using an electronic presentation controller, a computer, and a display device.

FIG. 2 illustrates an embodiment of an electronic presentation controller where an operating mode is selected using a mode selection button.

FIG. 3 illustrates the process for selecting an operating mode using the mode selection button.

FIG. 4 illustrates an embodiment of an electronic presentation controller where an operating mode is selected using a mode selection switch.

FIGS. 5a-d illustrate an embodiment of an electronic presentation controller where a moveable cover physically blocks access to some features of the electronic presentation controller.

FIGS. 6a-d illustrate an embodiment of an electronic presentation controller where a physical barrier disables certain features of the electronic presentation controller.

### DETAILED DESCRIPTION OF PREFERRED EMBODIMENTS

Electronic presentation software is commonly used in presentations of all types. A variety of electronic presentation software is available for creating and making electronic presentations. Presentations may include a variety of content, including multimedia content, such as audio and/or video content. Orators may also desire to display in an electronic presentation content from computing applications other than the electronic presentation application. For example, an orator may desire to show an Internet page, email message, or another computer application.

Orators frequently use a wireless electronic presentation controller that allows the orator to move away from a computer displaying the electronic presentation while retaining the ability to control the electronic presentation. An electronic presentation controller may allow the orator to advance or reverse the electronic presentation or to perform other functions on the computer. When an electronic presentation includes multimedia or other types of content, additional features may be required in order to effectively control the electronic presentation. For example, an orator may require an electronic presentation controller capable of controlling when a video plays as well as raising or lowering the volume of the video. In another circumstance, an orator may require an electronic presentation controller capable of switching between the electronic presentation and another application during the electronic presentation. In other circumstances, an orator may require the ability to suspend and resume an electronic presentation using the electronic presentation controller.

Controlling an electronic presentation while simultaneously delivering an electronic presentation divides the orator's attention between communicating the orator's message and managing the electronic presentation. Orators may also be forced to use unfamiliar presentation equipment that is installed at the location of the presentation, rather than familiar presentation equipment. The problem is exacerbated by electronic presentation controllers that are increasingly complex in order to allow for the use of varied content and presentation styles. These and other factors may contribute to an orator inadvertently taking an action that disrupts the presentation. For example, an orator may inadvertently exit the presentation application or may switch to another active application running on the computer. In addition to disrupting the presentation, such actions may cause embarrassment to the orator.

Accordingly, it is desirable to provide an electronic presentation controller that both minimizes the potential for unwanted actions while still providing all of the advanced functionality that may be required to control a multimedia presentation. Further, it is desirable to provide an electronic presentation controller that is easily understood and operated.

Disclosed herein are embodiments of an electronic presentation controller that allows an orator to select which features the orator will use during a presentation. Features that the orator will not use during the presentation may be disabled so that the unused features are not inadvertently invoked during the presentation. An electronic presentation controller according to the present disclosure may include a wide range of advanced features, such as the ability to control multimedia content and access to other programs running on the computer, while reducing the potential for unwanted and potentially embarrassing interruptions during the presentation. In certain embodiments, an orator may select an operating mode and disable functions of the electronic presentation controller that are not being used by the orator. The operating mode of the electronic presentation controller may be changed during a presentation as needed for invoking a desired function.

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

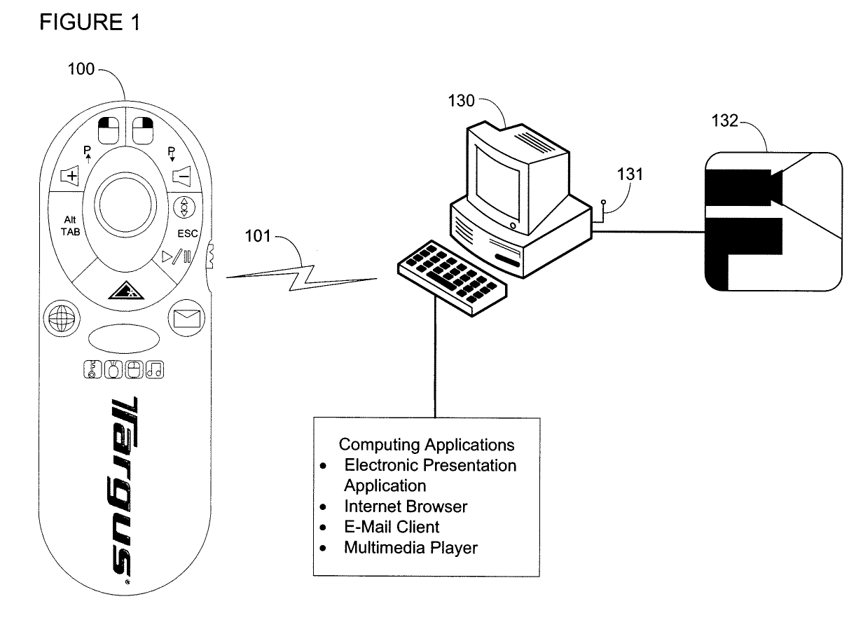

FIG. 1 illustrates an exemplary setup for an electronic presentation using one embodiment of an electronic presentation controller 100. Electronic presentation controller 100 is in communication with computer 130 via a communication link 101. Communication link 101 between electronic presentation controller 100 and computer 130 may be implemented in a variety of ways. For example, the electronic presentation controller 100 may transmit a signal to a companion receiver device 131 connected to computer 130. Electronic presentation controller 100 and companion receiver device 131 may communicate, for example, using radio frequencies in the 2.4 GHz frequency band. Companion receiver device 131 may connect to computer 130 using a USB port, a Fire Wire port, a serial port, or the like. In certain embodiments, companion receiver device 131 is natively supported by commonly used computer operating systems, such that it is not necessary to provide a driver in order to make use of electronic presentation controller 100. Communications link 101 between electronic presentation controller 100 and computer 130 may also be implemented using Bluetooth, wireless USB, Ultrawide band technologies, and the like.

Computer 130 is capable of receiving input from electronic presentation controller 100 and is capable of running a variety of computing applications. Such computing applications may include a program for creating and displaying electronic presentations (e.g., Microsoft PowerPoint, OpenOffice.org Impress, Corel Presentations, Apple Keynote, etc.); a program for browsing the Internet (e.g., Microsoft Internet Explorer, Mozilla Firefox, Netscape Navigator, etc.); an email client for sending and receiving email messages (e.g., Microsoft Outlook, Mozilla Thunderbird, Apple Mail, etc.); a multidmedia player for playing multimedia content (e.g., Microsoft Media Player, RealNetworks RealPlayer, Apple itunes, etc.). Computer 130 is also capable of connecting to a display device 132 that facilitates the display of an electronic presentation. Examples of display devices include the computer's monitor, video projectors, external displays, and the like.

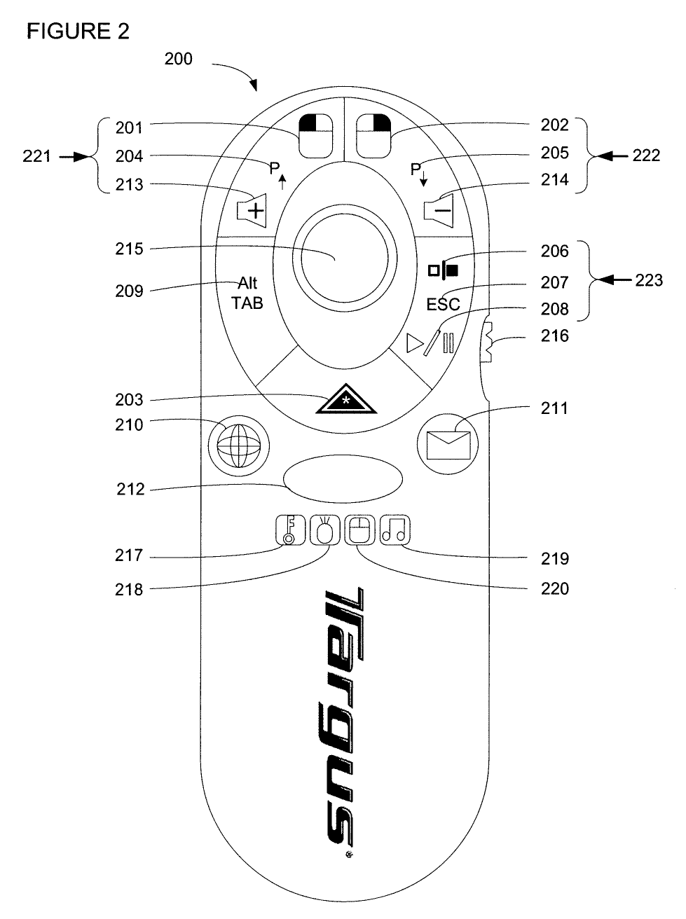

FIG. 2 illustrates one embodiment of an electronic presentation controller 200. Electronic presentation controller 200 includes four operating modes. The operating mode is selected by pressing mode selection button 212. The current operating mode may be specified by icons 217, 218, 219, and 220. In certain embodiments, icons 217, 218, 219, and 220 may be illuminated to indicate which operating mode is currently selected. In the embodiment illustrated in FIG. 2, the operating mode of electronic presentation controller 200 is changed each time mode selection button 212 is pressed. In the illustrated embodiment, a key icon represents key lock mode 217, a presenter icon represents presenter mode 218, a mouse icon represents mouse mode 220, and a music note icon represent multimedia mode 219.

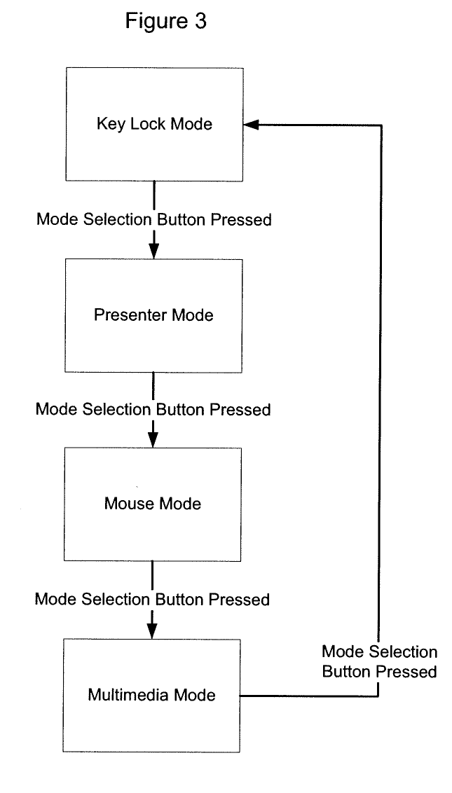

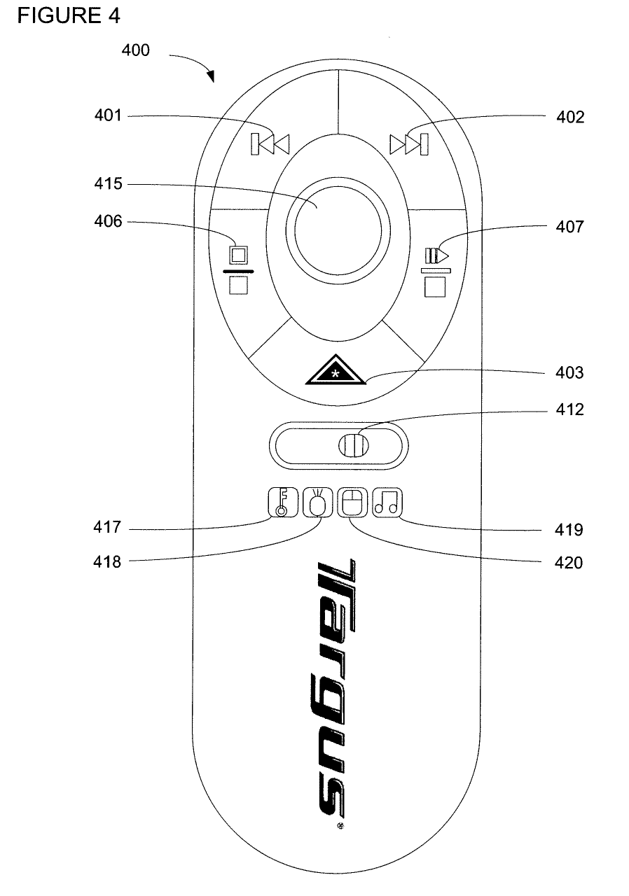

FIG. 3 is a flow chart illustrating one implementation for changing between the various operating modes. As illustrated in FIG. 3, an orator may select a desired operating mode by pressing mode selection button 212 and progressing through the operating modes until a desired operating mode is selected. Each time mode selection button 212 is pressed, electronic presentation controller 200 transitions to the next operating mode.

Returning to a discussion of FIG. 2, the functionality of electronic presentation controller 200 depends on the operating mode selected. In key lock mode 217, an orator may utilize page up input 204, page down input 205, and the laser pointer 203. The other buttons are disabled. Pressing page up input 204 may advance to the next slide in an electronic presentation, while pressing page down input 205 may reverse to the previous slide in an electronic presentation. Pressing laser pointer 203 activates a laser pointing device (not shown) for highlighting items of interest during a presentation. The laser pointing device may be a class I laser or the like. Key lock mode 217 is well-suited for electronic presentations that involve sequentially displaying electronic slides. Key lock mode 217 reduces the possibility that an inadvertent action will disrupt the presentation because the only active functions are for moving the presentation forward or backward, or activating the laser pointing device.

In presenter mode 218 all of the functions available in key lock mode 217 are available. In addition, an electronic presentation may be suspended or resumed using suspend/resume input 206. Suspend/resume input 206 functions to suspend the electronic presentation. This feature may be useful where an orator desires to use an electronic presentation for only a portion of a presentation. For example, during a presentation an orator may wish to utilize an electronic presentation at the beginning and end of a presentation, but may also desire to deactivate the electronic presentation during the presentation. In such a scenario, the orator may suspend the electronic presentation by pressing suspend/resume input 206, and resume the electronic presentation by pressing suspend/resume input 206 again.

In mouse mode 220, electronic presentation controller 200 enables standard mouse inputs, including cursor control input 215, left mouse input 201, and right mouse input 202. Cursor control input 215 is shown in FIG. 2 as a trackball, but may also be a joystick, pointing stick, or any other device capable of controlling a cursor on a computer system. In mouse mode 220, electronic presentation controller 200 may also enable ALT TAB input 209, ESC input 207, and laser pointer 203. ALT TAB input 209 invokes the function of pressing the ALT and TAB keys on a keyboard and is used on the Microsoft Windows operating system to switch between top-level windows. The list of tasks is kept in an order, with the most recently used tasks at the front. Each time ALT TAB input 209 is pressed, the computer will display the next task. A similar function may be invoked when electronic presentation controller 200 is used in connection with other operating systems. ESC input 207 performs any function that could be performed by pressing the ESC key on a keyboard. Mouse mode 220 may allow the orator all functionality allowed by using a standard mouse for controlling a computer cursor.

In multimedia mode 219, electronic presentation controller 200 may be used to control multimedia functions, such as play/pause input 208, Internet browser input 210, email client input 211, volume up input 213 and volume down input 214 and ALT TAB input 209. Multimedia mode 219 is well suited to controlling an electronic presentation containing video, audio, Internet based content, or displaying other applications running on the computer. For example, an orator may wish to display an Internet page during a presentation. An Internet browser may be opened by simply pressing on Internet browser input 210. In another example, an orator may wish to display another active computer application. The orator may toggle between the electronic presentation and another active computing application by simply pressing ALT TAB input 209.

As illustrated in FIG. 2, the same input may have a different function depending on the operating mode of an electronic presentation controller 200. In the illustrated embodiment, inputs 221, 222, and 223 each include three functions. As discussed above, in key lock mode 217, inputs 221 and 222 function respectively as page up and page down; whereas in multimedia mode, inputs 221 and 222 function respectively as volume up and volume down. By using inputs for multiple functions, interaction with electronic presentation controller 200 may be simplified. The correlation of the function of each input and the operating mode of electronic presentation controller 200 may be shown, for example, by a consistent layout or by use of color. Each operating mode may be associated with a different color. Functions that are active in each operating mode may be displayed in the same color. For example, the icon for mouse mode 220 may be green. Accordingly, left mouse input 201 and right mouse input 202 (the functions of inputs 221 and 222 respectively in mouse mode) may also be green. Similarly, the icon for multimedia mode 219 may be blue. Volume up input 213, volume down input 214, and play/pause input 208 (the functions of inputs 221, 222, and 223, respectively, in multimedia mode) may also be blue.

Electronic presentation controller 200 may include logic circuitry for selectively disabling inputs in the various operating modes described above and for toggling between different functions associated with inputs based on a selected operating mode. The logic circuitry may be configured to only transmit commands that are available in the selected operating mode and to not transmit commands that are disabled in the selected operating mode. Electronic presentation controller 200 may also include power switch 216 for manually turning the device on and off.

FIG. 4 shows another embodiment of an electronic presentation controller 400, where an operating mode is selected using a mode selection switch 412. Electronic presentation controller 400 includes the same operating modes that were discussed above with regard to electronic presentation controller 200. Icons 417-420 and the related operating modes correspond to icons 117-120 and the related operating modes discussed above. In the illustrated embodiment, inputs 401 and 402 display arrows. These arrows may function as described above to cause an electronic presentation to advance or reverse in key lock mode 417 and presenter mode 418, may act as left click and right click in mouse mode 420, and may raise and lower the volume in multimedia mode 419. Cursor control input 415 may be implemented as a joystick or other pointing control system, and may be disabled in all operating modes other than mouse mode 420. In the alternative, cursor control input 415 may be active in other operating modes to allow the orator to use the computer cursor to indicate various items of interest during the presentation or to allow the orator to interact with the computer. A multimedia control input 407 may be utilized in multimedia mode 419.

Various inputs disabled in the above-described operating modes may be physically disconnected based on the position of mode selection switch 412. In an alternative embodiment, electronic presentation controller 400, like electronic presentation controller 200, may include logic circuitry for controlling which inputs are disabled in each operating mode. In addition to the two methods for selecting an operating mode discussed in connection with electronic presentation controllers 200 and 400, there are many other ways to selectively disable inputs using logic circuitry. For example, the operating mode selection device may also be implemented using a revolving switch, a combination of inputs, etc. In yet another embodiment, all inputs may be disabled by default and only selectively enabled based on the operating mode.

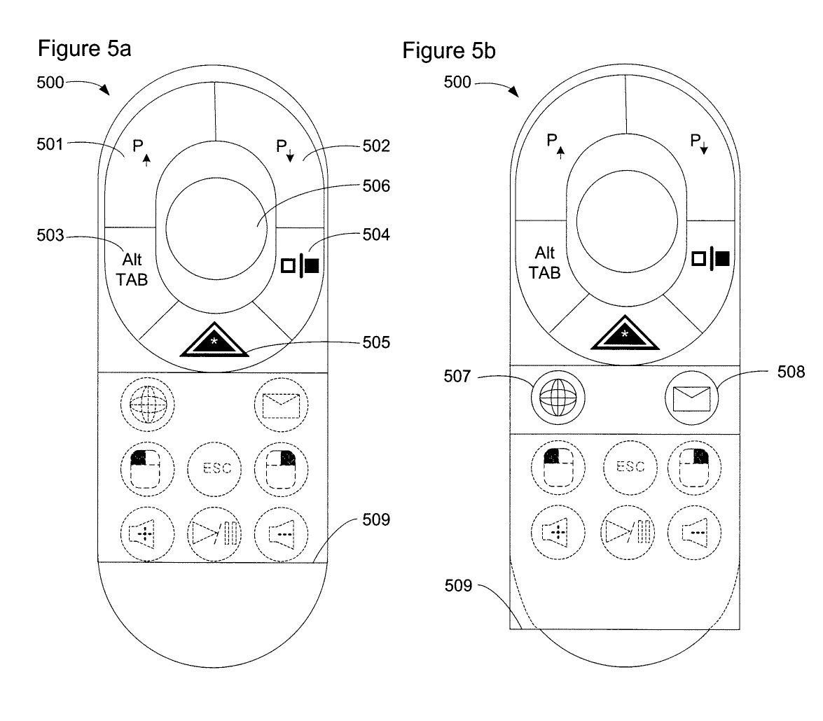

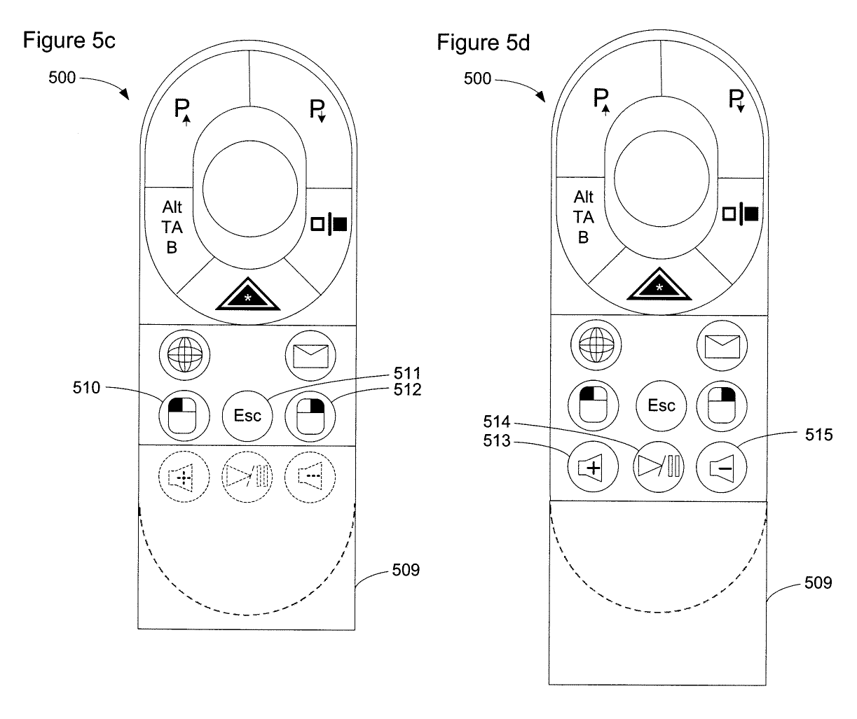

In another embodiment, a mechanical key lock may be employed. Many types of mechanical key locks may be employed, such as a moveable cover, a detachable cover, a cover with a hinge, a signal barrier, etc. FIGS. 5a-d illustrate an embodiment of a an electronic presentation controller 500 in which the key lock function is performed by a movable cover 509 that selectively covers inputs not being used by the orator. As illustrated in FIG. 5a, moveable cover 509 physically blocks access to various inputs (shown in phantom lines), and thus prevents the orator from unintentionally invoking the functions associated with the covered inputs. When the moveable cover 509 is in the position illustrated in FIG. 5a, the only functions available to the orator are page up input 501, page down input 502, ALT TAB input 503, suspend/resume input 504, laser pointer 505, and cursor control input 506.

FIG. 5b shows that cover 509 has been moved, exposing inputs for launching Internet browser 507 and email client 508. FIG. 5c shows that cover 509 has been moved, exposing left mouse input 510, ESC input 511, and right mouse input 512. Finally, FIG. 5d shows that the cover 509 has been moved, exposing inputs for volume up 513, play/pause 514, and volume down 515.

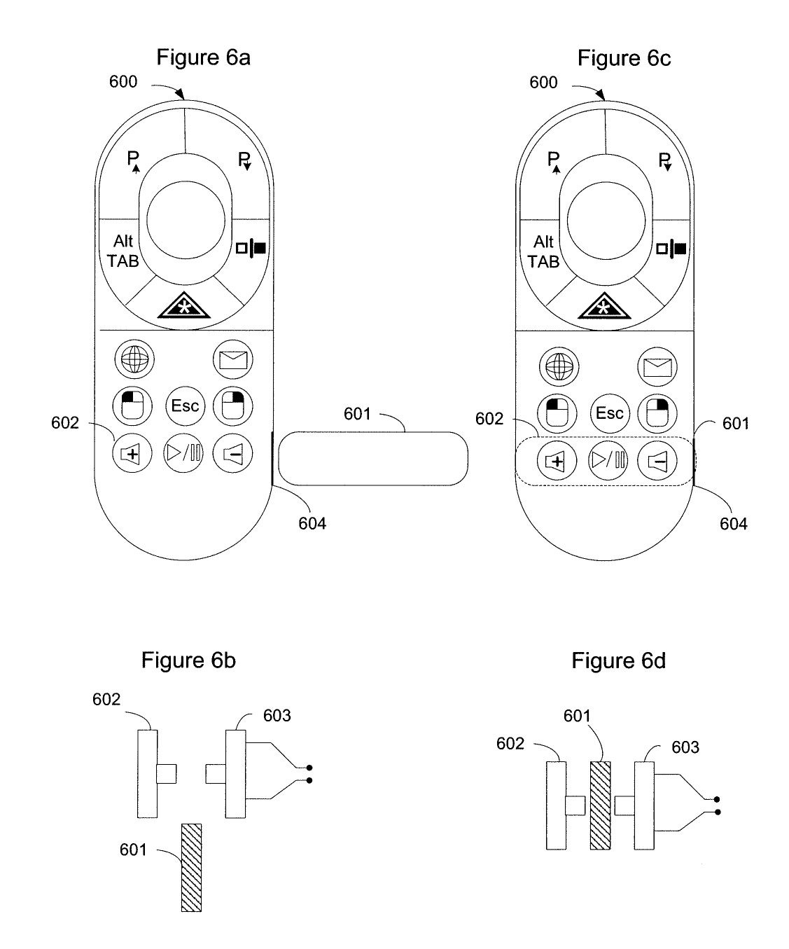

FIG. 6 illustrates an embodiment where a physical barrier is introduced between an actuator and a contact in order to lock the input. FIG. 6a illustrates electronic presentation controller 600 and illustrates physical barrier 601 in an unlocked position (i.e., outside of electronic presentation controller 600). Electronic presentation controller 600 may include opening 604 for receiving physical barrier 601. FIG. 6b shows that in operation, input actuator 602 may be depressed and come into contact with contact 603, thus transmitting a signal. FIG. 6c illustrates that signal barrier 601 has been moved into a locked position (i.e., inside of electronic presentation controller 600). FIG. 6d further illustrates that signal barrier 601 is disposed between input actuator 602 and contact 603, thus preventing the transmission of a signal and disabling input 602. In some embodiments, input actuator 602 and contact 603 may be embodied as a microswitch.

In another embodiment, input functions may be selectively disabled using a computer utility, such as a computer program. The computer utility may allow an orator to specify an operating mode, including the operating modes described above (e.g., key lock mode, presenter mode, mouse mode, and multimedia mode). In operation, an electronic presentation controller may transmit all input received from an orator to the computer utility. The computer utility may then compare input received from the electronic presentation controller, determine whether the input is active in the selected operating mode, and selectively pass the appropriate instruction, if any, to the computer for execution. For example, if an electronic presentation controller is in key lock mode and an Internet browser button is pressed, the computer utility may receive the command to launch an Internet browser, but may disregard the input because the Internet browser button is not active in key lock mode. Accordingly, the Internet browser button is locked by the computer utility because the command to launch the Internet browser is not executed by the computer.

The computer utility may also allow an orator to alter the function of one or more inputs of the electronic presentation controller. For example, referring to FIG. 2, if an orator desires to display a particular webpage during a presentation, the orator may enter the URL of the particular webpage using the computer utility such that when Internet browser input 210 is pressed, the Internet browser opens directly to the desired webpage. In another example, an orator may desire to employ the functionality of key lock mode 217 in order to minimize the possibility that an inadvertent action will disrupt the presentation, but may also require the functionality of play/pause input 208 in order to control a multimedia element in the presentation. In this example, the orator may specify using the computer utility that in addition to the functionality of key lock mode 217, described above, the functionality of play/pause input 208 is also enabled. In another example, email client input 211 may be enabled in presenter mode 218 such that an email message may be displayed during a presentation. Accordingly, the functionality of electronic presentation controller 200 may be further customized to the particular presentation using a computer utility.

While exemplary embodiments have been presented in the foregoing detailed description, it will be obvious to those having skill in the art that many changes may be made to the details of the above-described embodiments without departing from the underlying principles of the disclosure. The exemplary embodiments are meant to be illustrative, not limiting of the scope, applicability, or configuration of the present disclosure in anyway.

What is claimed is:

1. An electronic presentation controller to control an electronic presentation displayable on a computer system, the electronic presentation controller comprising:
a plurality of inputs corresponding to a plurality of features to control the operation of the electronic presentation;
wherein the controller is configured to operate in at least:
a first operating mode wherein the plurality of inputs correspond to a first set of features to control the electronic presentation, and
a second operating mode wherein the plurality of inputs correspond to a second set of features to control the electronic presentation; and
wherein at least one of the plurality of inputs corresponding to a feature available in the first set of features is disabled in the second operating mode.

2. The electronic presentation controller of claim 1, further comprising:
a first wireless transceiver in communication with the electronic presentation controller and configured to transmit a command received by the plurality of inputs;
a second wireless transceiver in communication with a computer system and configured to receive the command and to transmit the command to the computer system.

3. The electronic presentation controller of claim 1, further comprising a mode selection button, wherein at least one of the first and second operating modes are selectable wherein at least one of the first and second operating modes are selectable by pressing the mode selection button.

4. The electronic presentation controller of claim 1, further comprising a moveable switch, and wherein at least one of the first and second operating modes are selectable by moving the moveable switch.

5. The electronic presentation controller of claim 1, further comprising a moveable cover configured to physically block access to at least one of the plurality of inputs in at least one of the plurality of operating modes, and wherein at least one of the first and second operating modes are selectable by moving the moveable cover.

6. The electronic presentation controller of claim 1, further comprising a physical barrier, wherein at least one of the plurality of inputs comprises an actuator and a contact, the physical barrier configured to be received between the actuator and the contact of at least one of the plurality of inputs in at least one of the plurality of operating modes, and wherein the first operating mode and the second operating mode are selectable by the position of the physical barrier.

7. The electronic presentation controller of claim 1, further comprising a mechanical key lock and wherein at least one of the first and second operating modes are selectable by the mechanical key lock.

8. The electronic presentation controller of claim 1, wherein the second set of features is a subset of the first set of features.

9. The electronic presentation controller of claim 1, wherein the first set of features available in the first operating mode comprises:
an advance command to advance the electronic presentation,
a reverse command to reverse the position of an electronic presentation, and
a multimedia command to control a multimedia clip; and
wherein the second set of features comprises:
the advance command, and
the reverse command, and
wherein the multimedia command is disabled in the second operating mode.

10. The electronic presentation controller of claim 1, wherein the plurality of inputs comprises a mouse control input, and wherein the mouse control input is available in the first operating mode, and the mouse control input is disabled in the second operating mode.

11. The electronic presentation controller of claim 1, wherein the plurality of inputs comprises an Internet browser control input and an email client control input, and wherein the Internet browser control input and the email client control input are available in the first operating mode, and the Internet browser control input and the email client control input are disabled in the second operating mode.

12. The electronic presentation controller of claim 1, further comprising a computer utility configured to interface with a computer system, and wherein at least one of the first and second operating modes are selectable by the computer utility.

13. A method of controlling an electronic presentation displayable on a computer system, the method comprising:
coupling an electronic presentation controller to a computer system, the computer system configured to display an electronic presentation;
selecting between a plurality of operating modes of the electronic presentation controller, the plurality of operating modes including at least:
a first operating mode wherein the plurality of inputs correspond to a first set of features for controlling the electronic presentation, and
a second operating mode wherein the plurality of inputs correspond to a second set of features for controlling the electronic presentation; and
disabling in the second operating mode at least one of the plurality of inputs corresponding to a feature available in the first set of features;
receiving a command using a plurality of inputs of the electronic presentation controller; and
determining a feature corresponding to the command and the selected operating mode; and
implementing the determined feature to control the electronic presentation.

14. The method of claim 13, further comprising pressing a mode selection button of the electronic presentation controller to select between at least one of the first and second operating modes.

15. The method of claim 13, further comprising moving a switch of the electronic presentation controller to select between at least one of the first and second operating modes.

16. The method of claim 13, further comprising moving a cover of the electronic presentation controller to select between at least one of the first and second operating modes, the cover configured to physically block access to at least one of the plurality of inputs in at least one of the plurality of operating modes.

17. The method of claim 13, wherein at least one of the plurality of inputs comprises an actuator and a contact, and the method further comprises inserting a physical barrier between the actuator and the contact of at least one of the plurality of inputs to select between at least one of the first and second operating modes.

18. The method of claim 13, further comprising positioning a mechanical key lock of the electronic presentation controller to select between at least one of the first and second operating modes.

19. The method of claim 13, further comprising:
receiving a command from the plurality of inputs;
transmitting the command from a wireless transmitter of the electronic presentation controller to a wireless receiver in communication with the computer system.

20. The method of claim 13, wherein the second set of features is a subset of the first set of features.

21. The method of claim 13, configuring a computer utility to select between at least one of the first and second operating modes.

22. An electronic presentation controller to control an electronic presentation displayable on a computer system, the electronic presentation controller comprising:
means for coupling an electronic presentation controller to a computer system, the computer system configured to display an electronic presentation;
means for selecting between a plurality of operating modes of the electronic presentation controller, the plurality of operating modes including at least:
a first operating mode wherein a plurality of inputs correspond to a first set of features for controlling the electronic presentation, and
a second operating mode wherein the plurality of inputs correspond to a second set of features for controlling the electronic presentation; and
means for disabling in the second operating mode at least one of the plurality of inputs corresponding to a feature available in the first set of features;
means for receiving a command using a plurality of inputs of the electronic presentation controller; and
means for determining a feature corresponding to the command and the selected operating mode; and
means for implementing the determined feature to control the electronic presentation.
